(19) United States
(12) Patent Application Publication
(10) Pub. No.: US 2004/0055339 A1
(43) Pub. Date: Mar. 25, 2004

(54) Method for producing glass-particle deposited body

(76) Inventor: Tomohiro Ishihara, Kanagawa (JP)

Correspondence Address: MCDERMOTT WILL & EMERY, 600 13TH STREET, N.W., WASHINGTON, DC, 20005-3096, US

(21) Appl. No.: 10/399,194

(22) PCT Filed: Mar. 27, 2002
(86) PCT No.: PCT/JP02/02964

(30) Foreign Application Priority Data
Jun. 15, 2001 (JP) 2001-181778

(51) Int. Cl. C03B 37/018

(52) U.S. Cl. 65/414; 65/421; 65/379

(57) ABSTRACT

The present invention provides a method for manufacturing a glass particles deposit body that is formed on the periphery of a starting rod by an OVD method, whereby an optical fiber with enhanced optical transmission characteristics can be produced by reducing the number of disconnections and preventing the alien substances from being mixed into the glass particles deposit body. This invention involves the use of the OVD method in which (1) before or after starting to deposit fine glass particles, a reaction vessel is enclosed to suck and exhaust a gas within the reaction vessel after a removal operation of deposited fine glass particles from the inside of the reaction vessel, (2) when not in operation, a purge gas is passed at a flow rate of 1 m/min or more through each gas line of a burner, (3) when not in operation, a clean air (CA) is introduced into the reaction vessel to make the inner pressure of vessel positive, or (1) and (2) or (1), (2) and (3) are combined.

### FIELD OF THE INVENTION

The present invention relates to an improved method for manufacturing a glass particles deposit body (soot body) by an OVD method (outside vapor deposition), and more particularly to an improved method for manufacturing a glass particles deposit body with which an optical fiber with enhanced transmission characteristics can be produced by reducing the number of alien substances mixed into the glass particles deposit body.

### BACKGROUND ART

One of the methods for manufacturing the optical fiber preform is the OVD method. This OVD method is a method for forming a soot body on the periphery of a starting rod by flowing a glass-forming raw material gas, such as SiCl₄ or GeCl₄, together with an inert gas into a flame formed in fine glass particles synthesizing burner into which a fuel gas of H₂ and a stabilizing gas of O₂ are introduced, and depositing the fine glass particles of SiO₂ or GeO₂ produced by hydrolysis or oxidation reaction in the flame around the periphery of the starting rod in a radial direction, while the starting rod is being rotated around its central axis as a rotational axis, and moved relative to the burner. The formed soot body is vitrified by heating at high temperatures to have a glass parent material for optical fiber, which is drawn to produce an optical fiber.

By the way, all fine glass particles generated in the burner flame are not deposited to produce the glass particles deposit body, but partially float within a reaction vessel, in which these floating the fine glass particles stick to an inner wall of the reaction vessel to form a deposited layer. If the deposited layer is thickened to some extent, the deposited glass layer is exfoliated and drops down, so that scattered particles may be deposited onto the surface of soot body being produced. The scattered particles are deposited in different manner from the fine glass particles synthesized in the burner flame, and likely to cause voids in the glass body in the vitrification process.

Thus, it is common practice that after the end of depositing the fine glass particles, the apparatus inside is cleaned to remove the fine glass particles deposited within the apparatus. However, such a simple cleaning operation cannot completely remove the fine glass particles entered into the interstices of the apparatus or attached onto the apparatus.

A reaction vessel of this kind employs acid-proof metal material that is less worn by HCL produced through the hydrolysis reaction of glass raw material such as SiCl₄+2H₂O−>SiO₂+4HCl. However, if the production of soot body is stopped and some time elapses, the base material surface is dewed to produce a metal hydrate. Then, if the production of soot body is resumed, this metal hydrate is heated to become a metallic oxide, which is mixed into the soot body from the base material, resulting in a problem that the transmission characteristics of optical fiber may be affected.

A related art for preventing the alien substance such as hydrate from being mixed into the soot body was disclosed in JP-A-8-217480 (document 1). Herein, the material of the reaction vessel is limited to nickel (Ni) or Ni base alloy, and a control method, when the apparatus is not in operation, involves introducing an inert gas or clean air (abbreviated as CA) into the reaction vessel. This control method makes it possible to prevent the dewing, when not in operation, and prevent metal particles from being mixed into the soot body produced.

However, with the method of document 1, a large scale and expensive apparatus such as a CA generator (CAG) is needed. Also, with this method, it is difficult to remove excess the fine glass particles sticking to the inside of the apparatus after fabricating the soot body.

### SUMMARY OF THE INVENTION

The present invention uses the following constitutions [1] to [15] to solve the above-mentioned problems.

[1] A method for particles manufacturing a glass deposit body, which is an OVD method of depositing fine glass particles on the periphery of a starting rod within a reaction vessel, including sucking and exhausting a gas within the reaction vessel before starting to deposit the fine glass particles.

[2] The method for manufacturing the glass particles deposit body as defined in [1], further including sucking and exhausting the gas so that a pressure difference between inside and outside of an exhaust pipe may be 49 Pa or greater at a position having a distance x of 500 mm away from the reaction vessel.

[3] The method for manufacturing the glass particles deposit body as defined in [1], further including sucking and exhausting the gas for one minute or more.

[4] The method for manufacturing the glass particles deposit body as defined in [1], wherein a purge gas passing through each gas supply line of a glass particulate synthesizing burner when not in operation is controlled to have a flow rate of 1 m/min or more.

[5] The method for manufacturing the glass particles deposit body as defined in [4], wherein the purge gas is an inert gas.

[6] The method for manufacturing the glass particles deposit body as defined in [5], wherein the purge gas is N₂.

[7] The method for manufacturing the glass particles deposit body as defined in [1], wherein a clean air is introduced into the apparatus when not in operation, and the inner pressure of apparatus is controlled to be greater than the outer pressure of apparatus.

[8] A method for manufacturing a glass particles deposit body, which is an OVD method of depositing the fine glass particles on the periphery of a starting rod within a reaction vessel, wherein a clean air is introduced into the apparatus when not in operation, and the inner pressure of apparatus is controlled to be greater than the outer pressure of apparatus.

[9] The method for manufacturing the glass particles deposit body as defined in [8], wherein the clean air is introduced into the apparatus so that the degree of cleanness may be 1000/CF or less for the alien substance having a size of 0.3 μm or greater.

[10] The method for manufacturing the glass particles deposit body as defined in [8], wherein the inner pressure of apparatus is controlled so that a difference between the inner pressure and the outer pressure of the apparatus may be 10 Pa or more.

[11] The method for manufacturing the glass particles deposit body as defined in [7], wherein a purge gas passing through each gas supply line of the burner when not in operation is controlled to have a flow rate of 1 m/min or more.

[12] A method for manufacturing the glass particles deposit body, which is an OVD method of depositing the fine glass particles on the periphery of a starting rod within a reaction vessel, wherein a purge gas passing through each gas supply line of a burner when not in operation is controlled to have a flow rate of 1 m/min or more.

[13] The method for manufacturing the glass particles deposit body as defined in [12], wherein the purge gas is an inert gas.

[14] The method glass or manufacturing the particles deposit body as defined in [13], wherein the purge gas is N₂.

[15] The method for manufacturing the glass particles deposit body as defined in [12], wherein a clean air is introduced into the apparatus when not in operation, and the inner pressure of apparatus is controlled to be greater than the outer pressure of apparatus.

### BRIEF DESCRIPTION OF THE DRAWING

FIG. 1 is a concept view typically showing one embodiment of the present invention.

FIG. 2 is a schematic view showing a cross section of a burner employed in the examples 1 to 5 and the comparative examples 1, 2 of the invention, with the gases to be flowed.

FIG. 3 is an explanatory view typically showing a process for sucking and exhausting fine glass particles sticking to the inside of apparatus by increasing an exhaust pressure in this invention.

FIG. 4 is a perspective view showing one example of the downstream constitution of an exhaust pipe in this invention.

FIG. 5 is a typical diagram for explaining one embodiment of the upstream side of a gas supply line to one burner according to this invention.

FIG. 6 is a schematic view typically showing another embodiment of the invention.

FIG. 7 is a plan view of a reaction vessel of FIG. 6, as seen from the side of an upper lid.

In these figures, reference numeral 1 denotes a reaction vessel, 2 denotes an upper funnel, 3 denotes a lower funnel, 4 denotes a support rod, 5 denotes an upper lid, 6 denotes a glass rod, 7 and 8 denote a dummy rod, 9 denotes a starting rod, 10 denotes a quartz plate, 11, 12 and 13 denote a burner, 14 denotes a soot body, 15, 16 and 17 denote a gas supply line, 18, 19 and 20 denote a mass flow controller (hereinafter abbreviated as an MFC), 21 denotes an exhaust port, 22 denotes an exhaust pipe, 23 denotes a pressure gauge for measuring the pressure within the exhaust pipe, 24 denotes a fan, 25 denotes an excess air intake, 26 denotes the fine glass particles sticking to the inside of the upper funnel, 27 denotes the fine glass particles sticking to the inside of the reaction vessel, 28 to 32 denote a gas supply tank, 33 to 53 denote a gas supply line, 47′ to 53′ denote a gas supply line, 54 to 60 denote an MFC, 61 denotes a burner, 62 denotes a valve, 102 denotes a CA inlet pipe, 105 denotes an upper lid, 107 denotes a support rod inserting hole, 108 denotes a CA inlet opening, A denotes an aperture area, and x denotes a pressure measuring position within the exhaust pipe (distance from the reaction vessel)

### BEST MODE FOR CARRYING OUT THE INVENTION

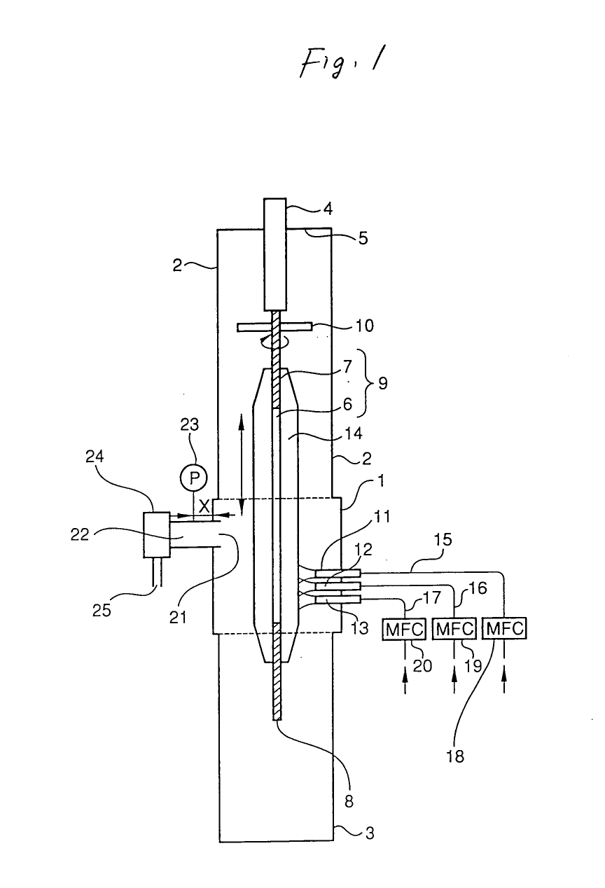

The preferred embodiments of the present invention will be described below with reference to the accompanying drawings. The same or like parts are designated by the common numerals throughout FIGS. 1 to 5, and the bold arrow of FIG. 1 indicates the motion direction. FIG. 1 is a schematic view typically showing an apparatus employed in one embodiment of the invention. Within the reaction vessel 1 having the upper funnel 2 with the upper lid 5 and the lower funnel 3, the starting rod 9 having the dummy rods 7 and 8 connected to both ends of the glass rod 6 having a core or a core and a clad is carried to be rotatable and movable in the up and down directions by the support rod 4. The fine glass particles formed in the flame from the burners 11, 12 and 13 are jetted on the starting rod 9, which is reciprocated in the up and down directions while being rotated, to form the soot body 14 in a radial direction of the starting rod. Reference numerals 15, 16 and 17 denotes gas supply lines for supplying a glass-forming raw material gas, a fuel gas, a stabilizing gas and an inert gas. Reference numerals 18, 19 and 20 denote MFCs. The reaction vessel 1 is provided with the exhaust port 21, in which an exhaust system has the exhaust pipe 22, the fans 22 and 25, and the excess air intake 25, and the pressure gauge 23 for measuring the inner pressure of exhaust pipe is provided at a position distance x away from the reaction vessel 1.

In this invention, before or after the process for fabricating the soot body by the OVD method, that is, when the apparatus is not in operation before or after activation, the fine glass particles remaining within the apparatus are removed almost completely, and the alien substance mixed into the burner and the gas supply line when the apparatus is not in operation is reduced, thereby solving the above-mentioned problems. Specifically, the following means (1) and (2) are employed.

(1) The apparatus is enclosed once or more since the end of producing the soot body till the start of producing the next soot body, whereby the exhaust amount of the exhaust pipe for sucking the air (gas) residing within the apparatus is increased to suck the fine glass particles sticking to the inside of the apparatus. With this work, the fine glass particles dropping into the reaction vessel are removed using a cleaner. Thereby, when the next batch is activated, the alien substance mixed into the soot body in a glass particles depositing process can be decreased. Also, when the exhaust amount is increased, a pressure difference between the inner pressure within the exhaust pipe and the outer pressure outside the exhaust pipe (within a room where the reaction vessel is placed) is set to be 49 Pa (about 5 mmH₂O) or greater at a position a distance x of 500 mm away from the reaction vessel, whereby the fine glass particles within the apparatus can be removed efficiently.

Also, the gas is sucked and exhausted for at least one minute or more to remove the alien substance within the apparatus efficiently.

(2) A purge gas is flowed through each gas supply line of burner at a flow rate of 1 m/min or more.

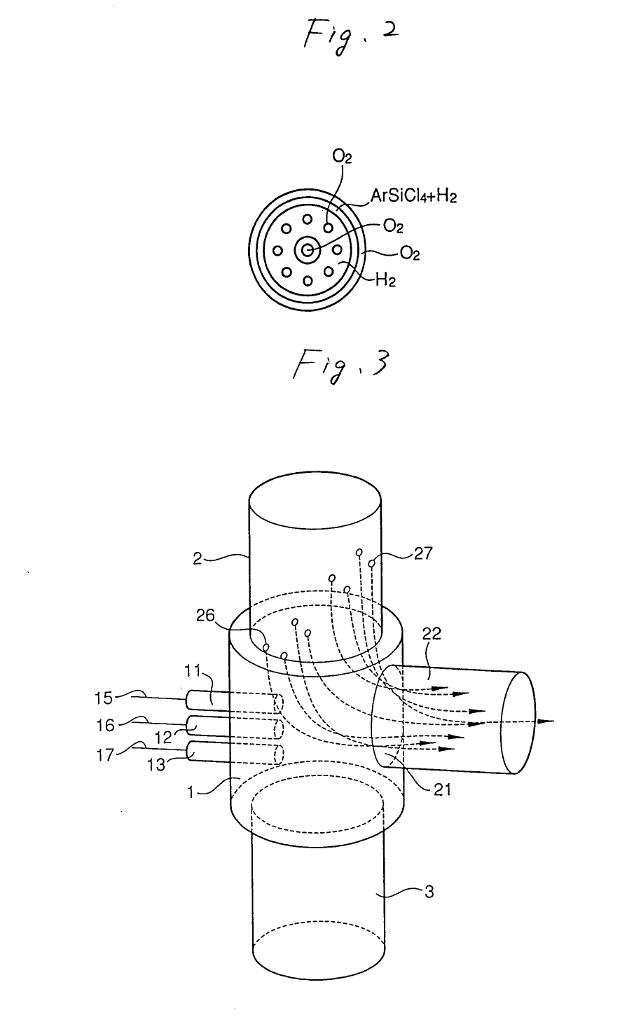

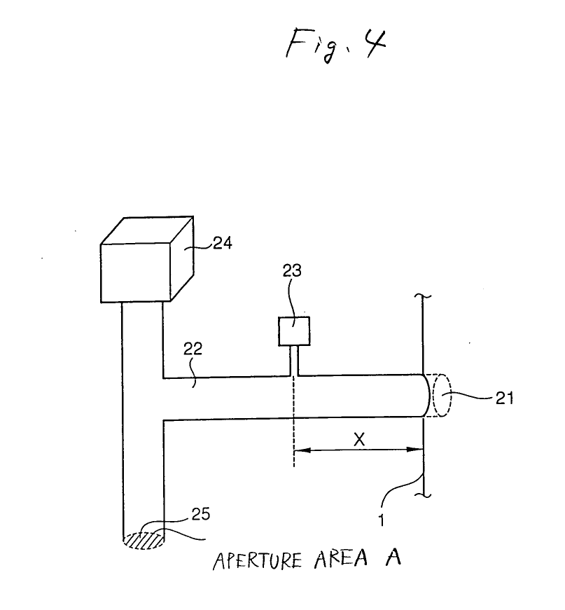

In this invention, if the gas is sucked and exhausted by increasing the amount of exhaust as described in (1), more amount of air flows through the interstices of the apparatus and the air flows through the apparatus at higher flow rate, whereby the fine glass particles 26, 27 sticking to the reaction vessel 1 or the upper funnel 2 of the apparatus can be removed efficiently as indicated by the arrow of broken line in FIG. 3.

Specific means for increasing the amount of exhaust involves increasing the number of rotations of the fan 24 connected to the downstream side of the exhaust pipe 22, or decreasing the aperture area A of the excess air intake 25 connected to the downstream side of the exhaust pipe 22, as shown in FIGS. 1 and 4. In FIGS. 1 and 4, the downstream structure of the exhaust pipe is typically shown only with the minimum and required parts. In FIG. 1, the gas supply line to the burner is simplified and typically shown.

By the way, with the burner itself for synthesizing the fine glass particles, there is a problem that the fine glass particles are attached and mixed. That is, a combustion gas and the glass-forming raw material gas are blown out of the top end of the burner at the same time, but part of the blown gases is diffused in the radial direction of the burner to adhere to the top end or near the exit of the burner as the fine glass particles. Also, the fine glass particles may be mixed internally due to entrainment of outer air near the exit of the burner. If the fine glass particles attached or mixed to or into the burner are left behind, the fine glass particles mixed in the next synthesis of parent material fly out of the burner to stick to the surface of porous glass parent material, but they are deposited in a different manner from the fine glass particles synthesized in the flame and deposited immediately, thereby causing the voids to be produced in the vitrification process. Further, deposited fine glass particles are vitrified within the burner, due to heat of the combustion gas, so that the burner itself may become unusable.

Thus, in this invention, the purge gas is flowed at a flow rate of 1 m/min or more, when the apparatus is not in operation, as described in (2), whereby the alien substance mixed into each gas supply line of the burner can be reduced.

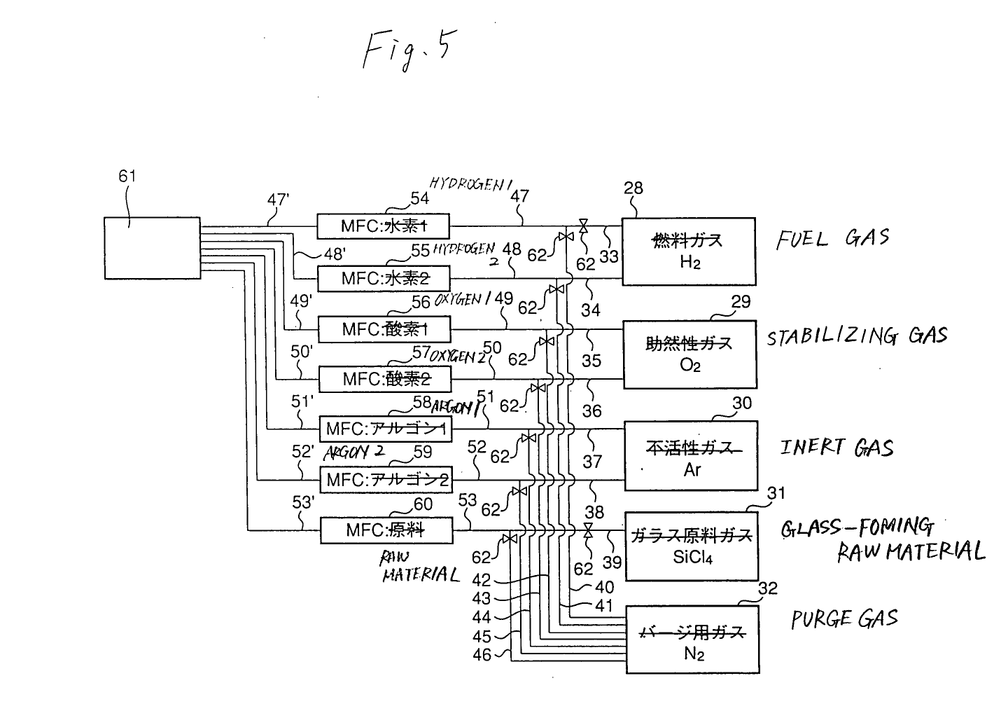

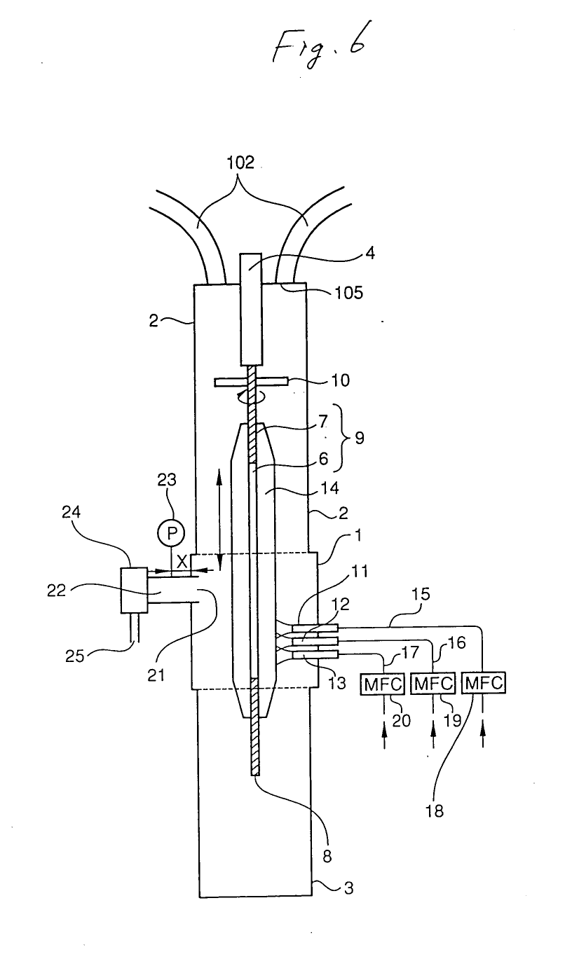

Though one gas supply line to each burner is typically shown to avoid a complex view in FIG. 1, MFC is installed upstream of the gas supply line for each of the glass-forming raw material gas (SiCl₄), fuel gas (H₂), stabilizing gas (O₂), inert gas (argon), and purge gas (N₂) to control each gas flow rate individually. For example, FIG. 5 is a view for explaining the gas supply line to one burner in one embodiment of the invention. The gases from the gas supply tanks 28 to 32 are introduced through the gas supply lines 33 to 53 and 47′ to 53′ into the burner 61, respectively. The mass flow controllers (MFC). 54 to 60 are mounted in the gas supply lines 47 to 53, respectively, each MFC having a different maximum flow rate. A valve 62 is mounted in each of the gas supply lines 33 to 52, as shown in the figure. By switching this valve, a purge gas (N₂ in the shown example) can be flowed through each line 47 to 53, when the apparatus is not in operation. This purge gas is controlled to have a flow rate of 1 m/min or more, so that gas is flowed through each line 47′ to 53′ at a flow rate of about 0.17 m/s or more to prevent the alien substance from being mixed from the burner 61 into each gas supply line 47′ to 53′. Also, there is the effect that the alien fine glass particles (hereinafter abbreviated as alien substance) adhering to the burner 61 can be blown away.

The sorts of purge gas used here preferably include the inert gas, and among others, N₂ is beneficial in the respect of cost.

A combination of (1) and (2) as above cited may be naturally included within the scope of this invention.

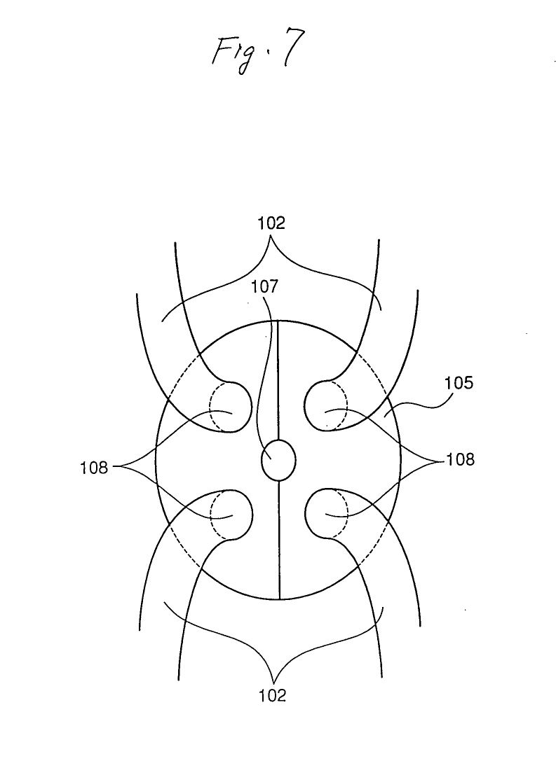

Another embodiment of this invention will be described below. FIG. 6 is a schematic view typically showing an apparatus employed in another embodiment of the invention. FIG. 7 is a plan view of the apparatus of FIG. 6, as seen from the above. This another embodiment is constituted in the same manner as the previous embodiment, except that CA is introduced into the reaction vessel. Accordingly, the same or like parts are designated by the same numerals, and not described.

In this another embodiment, an upper lid 105 having a CA inlet pipe 102 is placed on the upper funnel 2 of the reaction vessel 1 to enable CA to be introduced into the vessel from the outside. The CA inlet pipes 102 are connected with a plurality of CA inlet openings 108 formed around a support rod inserting hole 107 provided in the center of the upper lid 105 to allow the support rod 4 to pass through, as shown in FIG. 7. In this embodiment, four CA inlet pipes 102 are provided.

In this invention, before or after the process for fabricating the soot body by the OVD method, namely, when the apparatus is not in operation before or after activation, the fine glass particles residual within the apparatus are removed almost completely, the alien substance adhering to the burner or mixed into the gas supply line when the apparatus is not in operation is reduced, and the outer air is prevented from entering into the apparatus, thereby solving the aforementioned problems. Specifically, the following means (1), (2) and (3) are employed.

(1) The apparatus is enclosed once or more since the end of producing the soot body till the start of producing the next soot body, whereby the exhaust amount of the exhaust pipe for sucking the air (gas) residing within the apparatus is increased to suck fine glass particles sticking to the inside of the apparatus. With this work, fine glass particles dropping into the reaction vessel are removed out of the apparatus. Thereby, when the next batch is activated, the alien substance (dust, metal, metallic oxide, glass residue) mixed into the soot body in a glass particles depositing process can be decreased.

Also, when the exhaust amount is increased, a pressure difference between the inner pressure within the exhaust pipe and the outer pressure outside the exhaust pipe (inside and outside of the exhaust pipe) is set to be 49 Pa (about 5 mmH₂O) or greater at a position a distance x of 500 mm away from the reaction vessel, whereby the fine glass particles within the apparatus can be removed efficiently.

(2) A purge gas is flowed through each gas supply line of burner at a flow rate of 1 m/min or more from the end of producing the soot body till the start of producing the soot body.

(3) CA is introduced into the apparatus and the inner pressure within the apparatus is controlled to be greater than the outer pressure outside the apparatus from the end of producing the soot body till the start of producing the soot body, whereby the alien substance in the outer air can be prevented from entering into the apparatus.

Also, the clean air is introduced into the apparatus so that the degree of cleanness may be 1000/CF or less for the number of dusts having a size of 0.3 μm or greater, and the pressure within the apparatus is controlled so that a difference between the inner pressure and the outer pressure of the apparatus may be 10 Pa or more, whereby there is the effect that the outer air entering into the apparatus is reduced.

In this invention, if the gas is sucked and exhausted by increasing the amount of exhaust as described in. (1), more amount of air flows through the interstices of the apparatus and the air flows through the apparatus at higher flow rate, whereby the fine glass particles 26, 27 sticking to the reaction vessel 1 or the upper funnel 2 of the apparatus can be removed efficiently as indicated by the arrow of broken line in FIG. 3.

As cited above in (2), a purge gas is flowed at a flow rate of 1 m/min or more when the apparatus is not in operation, whereby the alien substance mixed into each gas supply line of burner can be reduced.

Also, when the outer air contains a great number of alien substances, the alien substance in the outer air enters into the apparatus, when not in operation, resulting in a problem that when the soot body is produced, the alien substance is mixed into the soot body.

Thus, in this invention, as cited above in (3), CA is introduced into the apparatus, when not in operation, and the pressure within the apparatus is controlled to be greater than the atmospheric pressure, whereby the alien substance residing in the atmosphere is prevented from being mixed into the soot body.

A combination of (1), (2) and (3) as above cited may be employed, and included within the scope of the invention.

Before the start of depositing the fine glass particles as used herein includes the non-operation time when the fine glass particles are not deposited. Particularly, it preferably means immediately before the start of depositing the fine glass particles.

The alien substance floats or sticks within the reaction vessel before the start of depositing the fine glass particles, and means metal or metallic oxide separated out of the reaction vessel of apparatus, or alien glass particulate.

Moreover, when the gas residing within the apparatus is sucked and exhausted, the alien substance adhering within the reaction vessel may be peeled by placing the interior of the reaction vessel at a negative pressure for a certain period of time or more, exhausted, and removed.

It is desirable that by sucking and exhausting the gas, the alien substance dropping into the lower parts of the apparatus such as lower funnel and lower portion of the reaction vessel (around the exhaust pipe) is removed out of the apparatus. This suction and exhaustion is made by a cleaner or through a negative pressure process as above cited.

### EXAMPLES

### Example 1

Using an apparatus having the reaction vessel 1 (internal diameter 310 mm), the upper funnel 2 (internal diameter 300 mm) and the lower funnel 3 (internal diameter 300 mm) as shown in FIG. 1, the fine glass particles were deposited.

The upper lid 5 having a hole (internal diameter 55 mm) for inserting the support rod 4 (external diameter 50 mm) was placed on the upper funnel 2. A starting rod 9 was fabricated by welding the dummy rods 7 and 8 made of quartz glass on both sides of the glass rod 6 (500 mm) with a diameter 30 mm having the core and clad portion, and a quartz disc 10 for thermal insulation was attached to the upper dummy rod 7. The starting rod 9 was mounted on the support rod 4, and placed vertically by rotating it at 40 rpm. While the starting rod 9 was being traversed 1100 mm upward and downward at a rate of 200 mm/min, the fine glass particles were blown out in the flames from the burners 11, 12 and 13 and deposited successively on the starting rod 9 to produce the soot body 14.

At this time, the raw material gas SiCl₄:4SLM (standard litter/min) was supplied to each of three burners 11, 12 and 13 (diameter 30 mm, spacing 150 mm), and H₂:80SLM and O₂:40SLM to form the flame, and Ar:2SLM as a seal gas were supplied to three burners. FIG. 2 typically illustrates a cross section of a gas port for the burner 11. In this example, the burners 12 and 13 had the same cross section of gas port.

The inner pressure within the exhaust pipe while depositing the fine glass particles was controlled so that a pressure difference at the position with a distance x of 500 mm (hereinafter measurement of pressure difference was made at x=500 mm) might be 49 Pa (about 5 mmH₂O). This operation was repeated to obtain the target glass layer thickness of 30 mm (glass diameter of 93 mm, core rod diameter of 33 mm), and when the soot body having an external diameter of 200 mm was finally produced, the soot body was taken out of the apparatus.

Thereafter, the apparatus was cleaned inside. During the cleaning, the inner pressure of the exhaust pipe 2 installed in the reaction vessel 1 was controlled to have a pressure difference of 98.1 Pa (about 10 mm H₂O). The fine glass particles adhering to the reaction vessel 1 and the upper funnel 2 were sucked into the exhaust port 22, as shown in FIG. 3. Also, the fine glass particles having fallen from the upper funnel 2 into the reaction vessel 1 were removed using a cleaner. Two hours after that or immediately before the start of producing the next soot body, the inner pressure of the exhaust pipe was controlled to have a pressure difference of 147.1 Pa (about 15 mm H₂O), and the amount of exhaust to suck the gas through the exhaust port was increased. As a result, the fine glass particles that could not be removed by the cleaning at the previous time were sucked out. Also, the fine glass particles having fallen into the reaction vessel 1 were removed using the cleaner.

Thereafter, the fine glass particles were deposited again using the apparatus as shown in FIG. 1. The upper lid 5 having a hole (internal diameter 55 mm) for inserting the support rod 4 (external diameter 50 mm) was placed on the upper funnel 2. A starting rod 9 was fabricated by welding the dummy rods 7 and 8 made of quartz glass on both sides of the glass rod 6 (500 mm) with a diameter 30 mm having the core and clad portion, and the quartz disc 10 for thermal insulation was attached to the upper dummy rod 7. The starting rod 9 was mounted on the support rod 4, and placed vertically by rotating it at 40 rpm. While the starting rod 9 was being traversed 1100 mm upward and downward at a rate of 200 mm/min, the fine glass particles were blown out in the flames from the burners 11, 12 and l3 and deposited successively on the starting rod 9 to produce the soot body 14.

At this time, the raw material gas SiCl₄:4SLM was supplied to each of three burners 11, 12 and 13, and H₂:80SLM and O₂:40SLM to form the flame, and Ar:2SLM as the seal gas were supplied to three burners. The inner pressure within the exhaust pipe while depositing the fine glass particles was controlled so that a pressure difference might be 49 Pa (about 5 mmH₂O). This operation was repeated to obtain the target glass layer thickness of 30 mm (glass diameter of 93 mm, core rod diameter of 33 mm), so that the soot body had an external diameter of 200 mm. This soot body was heated at high temperatures, vitrified, and fiberized. In the screening test conducted thereafter, it was revealed that the number of disconnections was as excellent as once per 100 km.

The screening test is a strength test for the optical fiber that is conducted before the shipment of products. Usually, in the optical fiber for submarine cable, a load (1.8 to 2.2 kgf) was applied to have a stretching ratio of 2% in the longitudinal direction of optical fiber, and a portion of lower strength is cut out before the shipment. In this screening test, if there are more fiber disconnections, the examination frequency or the number of connections is increased, so that the final cost of optical fiber is increased many times as compared with when there are few disconnections.

### Example 2

Using the apparatus of the example 1, the soot body with an external diameter of 200 mm was produced under the same conditions for depositing the soot body including the starting rod and deposition conditions as in the example 1. This soot body was taken out of the apparatus.

Thereafter, the flow rate of the gas supply line of burner was set at 30% of the maximum flow rate for each MFC, and the apparatus was cleaned by flowing N₂ through each gas supply line.

Two hours later after the end of cleaning, using the apparatus of the example 1, the soot body was produced again under the same conditions for depositing the soot body including the starting rod and deposition conditions as in the example 1, and the soot body had an external diameter of 200 mm. This soot body was heated at high temperatures, and vitrified to produce a vitreous body with a glass diameter of 93 mm and a core rod diameter of 33 mm. This vitreous body was drawn to obtain the optical fiber. In the screening test conducted thereafter, it was revealed that the number of disconnections was as excellent as twice per 100 km.

### Example 3

Using an apparatus having the reaction vessel 1 (internal diameter 310 mm) made of Ni, the upper funnel 2 (internal diameter 300 mm) and the lower funnel 3 (internal diameter 300 mm) as shown in FIG. 6, the fine glass particles were deposited.

The upper lid 105 having a support rod inserting hole 107 (internal diameter 55 mm) and a CA inlet pipe 102 was placed on the upper funnel 2. A starting rod 9 was fabricated by welding the dummy rods 7 and 8 made of quartz glass on both sides of the glass rod 6 (500 mm) with a diameter 30 mm having the core and clad portion, and a quartz disc 10 for thermal insulation was attached to the upper dummy rod 7. The starting rod 9 was mounted on the support rod 4, and placed vertically by rotating it at 40 rpm. While the starting rod 9 was being traversed 1100 mm upward and downward at a rate of 200 mm/min, the fine glass particles were blown out in the flames from the burners 11, 12 and 13 and deposited successively on the starting rod 9 to produce the soot body 14.

At this time, the raw material gas SiCl₄:4SLM was supplied to each of three burners 11, 12 and 13, and H₂:80SLM and O₂:40SLM to form the flame, and Ar:2SLM as the seal gas were supplied to three burners.

The inner pressure within the exhaust pipe while depositing the fine glass particles was controlled so that a pressure difference at the position with a distance x of 500 mm might be 49 Pa (about 5 mmH₂O). This operation was repeated to obtain the target glass layer thickness of 30 mm (glass diameter of 93 mm, core rod diameter of 33 mm), and when the soot body having an external diameter of 200 mm was finally produced, the soot body was taken out of the apparatus, and the apparatus was cleaned inside.

After cleaning, the inner pressure of the exhaust pipe 21 installed in the reaction vessel 1 was controlled to have a pressure difference of 98.1 Pa (about 10 mmH₂O) for ten minutes. the fine glass particles adhering to the reaction vessel 1 and the upper funnel 2 were sucked into the exhaust port 22, as shown in FIG. 3. Also, the fine glass particles having fallen from the upper funnel 2 into the reaction vessel 1 were removed using a cleaner. Thereafter, the pressure within the apparatus was controlled to have the same value as the outer pressure of the apparatus. Also, immediately before the start of producing the next soot body, the inner pressure of the exhaust pipe 21 was controlled to have a pressure difference of 147.1 Pa (about 15 mm H₂O) for ten minutes, and the amount of exhaust to suck the gas through the exhaust port 22 was increased. As a result, the fine glass particles that could not be removed by the cleaning at the previous time were further sucked out. Also, the fine glass particles having fallen into the reaction vessel 1 were removed using the cleaner.

Thereafter, the fine glass particles were deposited again using the apparatus as shown in FIG. 6. The upper lid 5 having the support rod inserting hole 107 (internal diameter 55 mm) for inserting the support rod 4 (external diameter 50 mm) was placed on the upper funnel 2. A starting rod 9 was fabricated by welding the dummy rods 7 and 8 made of quartz glass on both sides of the glass rod 6 (500 mm) with a diameter 30 mm having the core and clad portion, and the quartz disc 10 for thermal insulation was attached to the upper dummy rod 7. The starting rod 9 was mounted on the support rod 4, and placed vertically by rotating it at 40 rpm. While the starting rod 9 was being traversed 1100 mm upward and downward at a rate of 200 mm/min, the fine glass particles were blown out in the flames from the burners 11, 12 and 13 and deposited successively on the starting rod 9 to produce the soot body 14. At this time, the raw material gas SiCl₄:4SLM was supplied to each of three burners 11, 12 and 13, and H₂:80SLM and O₂:40SLM to form the flame, and Ar:2SLM as the seal gas were supplied to three burners. The inner pressure within the exhaust pipe while depositing the fine glass particles was controlled to have a pressure difference of 49 Pa (about 5 mmH₂O). This operation was repeated to obtain the target glass layer thickness of 30 mm (glass diameter of 93 mm after vitrification), so that the soot body having an external diameter of 200 mm was produced. This soot body was heated at high temperatures, vitrified, and fiberized. In the screening test conducted thereafter, it was revealed that the number of disconnections was as excellent as once per 100 km.

### Example 4

Using the apparatus of the example 3 as shown in FIG. 6, the soot body with an external diameter of 200 mm was produced under the same conditions for depositing the soot body including the starting rod and deposition conditions as in the example 3. This soot body was taken out of the apparatus.

Thereafter, the flow rate of the gas supply line of burner was set at 30% (flow rate of 3 m/min) of the maximum flow rate for each MFC, and the apparatus was cleaned by flowing N₂ through each gas supply line.

After the cleaning, the same purge gas of N₂ was continuously flowed.

Two hours later after the end of cleaning, using the apparatus of FIG. 6, the soot body was produced again under the same conditions for depositing the soot body including the starting rod and deposition conditions as in the example 3, so that the soot body had an external diameter of 200 mm. This soot body was heated at high temperatures, and vitrified to produce a vitreous body with a glass diameter of 93 mm. This vitreous body was drawn to obtain the optical fiber. In the screening test conducted thereafter, it was revealed that the number of disconnections was as excellent as twice per 100 km.

### Example 5

Using the apparatus of the example 3 as shown in FIG. 6, the soot body with an external diameter of 200 mm was produced under the same conditions for depositing-the soot body including the starting rod and deposition conditions as in the example 3. This soot body was taken out of the apparatus, and the apparatus was cleaned inside.

After the cleaning, the CA (10/CF for the alien substances having size of 0.3 μm or greater) was introduced at a flow rate of 15 m³/min into the apparatus so that there was a pressure difference between the inner pressure of the apparatus and the outer pressure of the apparatus being 60 Pa, and controlled for two hours.

Thereafter, using the apparatus of the example 3 as shown in FIG. 6, the soot body with an external diameter of 200 mm was produced again under the same conditions for depositing the soot body including the starting rod and deposition conditions as in the example 3. This soot body was heated at high temperatures, and vitrified to produce a vitreous body with a glass diameter of 93 mm. This vitreous body was drawn to obtain the optical fiber. In the screening test conducted thereafter, it was revealed that the number of disconnections was as excellent as twice per 100 km.

### Comparative Example 1

Using the apparatus of the example 1 as shown in FIG. 1, the soot body with an external diameter of 200 mm was produced under the same conditions for depositing the soot body including the starting rod and deposition conditions as in the example 1. This soot body was taken out of the apparatus.

Thereafter, the apparatus was cleaned inside. During the cleaning, the inner pressure of the exhaust pipe 22 installed in the reaction vessel was controlled to have a pressure difference of 0 Pa, and no gas was exhausted. Also, N₂ was flowed at a flow rate (0.2 m/min) of 2% of the maximum flow rate of MFC through each of the gas supply lines 15, 16 and 17 of the burners 11, 12 and 13.

Immediately after the cleaning, using the apparatus of the example 1 as shown in FIG. 1, the soot body with an external diameter of 200 mm was produced again under the same conditions for depositing the soot body including the starting rod and deposition conditions as in the example 1. This soot body was heated at high temperatures, and vitrified to produce a vitreous body with a glass diameter of 93 mm and a core rod diameter of 0.33 mm. This vitreous body was drawn to obtain the optical fiber. In the screening test conducted thereafter, it was revealed that the number of disconnections was as many as fifteen times per 100 km

In this comparative example 1, the soot body was produced again immediately after the cleaning. However, when the apparatus was left intact for two hours after the end of cleaning, and then the soot body was produced, the same result as in the comparative example 1 was obtained.

### Comparative Example 2

Using the apparatus of the example 3 as shown in FIG. 6, the soot body with an external diameter of 200 mm was produced under the same conditions for depositing the soot body including the starting rod and deposition conditions as in the example 3. This soot body was taken out of the apparatus. Thereafter, the apparatus was cleaned inside. During the cleaning, the inner pressure of the exhaust pipe 22 installed in the reaction vessel was controlled to have a pressure difference of 0 Pa, and no gas was exhausted. Also, N₂ was flowed at a flow rate (0.2 m/min) of 2% of the maximum flow rate of MFC through each of the gas supply lines 15, 16 and 17 of the burners 11, 12 and 13. After the cleaning, no CA was introduced into the apparatus, so that the pressure difference between the inner pressure of the apparatus and the outer pressure of the apparatus was 0 Pa.

Immediately after the cleaning, using the apparatus of the example 3 as shown in FIG. 6, the soot body with an external diameter of 200 mm was produced again under the same conditions for depositing the soot body including the starting rod and deposition conditions as in the example 3. This soot body was heated at high temperatures, and vitrified to produce a vitreous body with a glass diameter of 93 mm. This vitreous body was drawn to obtain the optical fiber. In the screening test conducted thereafter, it was revealed that the number of disconnections was as many as fifteen times per 100 km

In this comparative example 2, the fine glass particles were deposited again immediately after the cleaning. However, when the apparatus was controlled so that the inner pressure might be equal to the outer pressure for two hours after the end of cleaning, and then the fine glass particles were deposited, the screening test indicated that the number of disconnections was twenty times per 100 km.

### INDUSTRIAL APPLICABILITY

As above described, with this invention, it is possible to manufacture a soot body by the OVD method, whereby an optical fiber with enhanced optical transmission characteristics can be produced by reducing the number of disconnections in the fiber in a drawing process and preventing the alien substance from being mixed into the soot body, with the lower apparatus cost.

What is claimed is:

1. A method for manufacturing a glass particles deposit body, which is an OVD method of depositing fine glass particles on the periphery of a starting rod within a reaction vessel, including sucking and exhausting a gas within said reaction vessel before starting to deposit said fine glass particles.

2. The method for manufacturing the glass particles deposit body according to claim 1, further including sucking and exhausting said gas so that a pressure difference between inside and outside of an exhaust pipe may be 49 Pa or greater at a position having a distance x of 500 mm away from the reaction vessel.

3. The method for manufacturing the glass particles deposit body according to claim 1, further including sucking and exhausting said gas for one minute or more.

4. The method for manufacturing the glass particles deposit body according to claim 1, wherein a purge gas passing through each gas supply line of a glass particulate synthesizing burner when not in operation is controlled to have a flow rate of 1 m/min or more.

5. The method for manufacturing the glass particles deposit body according to claim 4, wherein said purge gas is an inert gas.

6. The method for manufacturing the glass particles deposit body according to claim 5, wherein said purge gas is N₂.

7. The method for manufacturing the glass particles deposit body according to claim 1, wherein a clean air is introduced into the apparatus when not in operation, and the inner pressure of apparatus is controlled to be greater than the outer pressure of apparatus.

8. A method for manufacturing a glass particles deposit body, which is an OVD method of depositing fine glass particles on the periphery of a starting rod within a reaction vessel, wherein a clean air is introduced into the apparatus when not in operation, and the inner pressure of apparatus is controlled to be greater than the outer pressure of apparatus.

9. The method for manufacturing the glass particles deposit body according to claim 8, wherein the clean air is introduced into the apparatus so that the degree of cleanness may be 1000/CF or less for the alien substance having a size of 0.3 μm or greater.

10. The method for manufacturing the glass particles deposit body according to claim 8, wherein the inner pressure of apparatus is controlled so that a difference between the inner pressure and the outer pressure of the apparatus may be 10 Pa or more.

11. The method for manufacturing the glass particles deposit body according to claim 7, wherein a purge gas passing through each gas supply line of said burner when not in operation is controlled to have a flow rate of 1 m/min or more.

12. A method for manufacturing a glass particles deposit body, which is an OVD method of depositing fine glass particles on the periphery of a starting rod within a reaction vessel, wherein a purge gas passing through each gas supply line of a burner when not in operation is controlled to have a flow rate of 1 m/min or more.

13. The method for manufacturing the glass particles deposit body according to claim 12, wherein said purge gas is an inert gas.

14. The method for manufacturing the glass particles deposit body according to claim 13, wherein said purge gas is N₂.

15. The method for manufacturing the glass particles deposit body according to claim 12, wherein a clean air is introduced into the apparatus when not in operation, and the inner pressure of apparatus is controlled to be greater than the outer pressure of apparatus.
